(19) United States
(12) Patent Application Publication
(10) Pub. No.: US 2021/0351954 A1
(43) Pub. Date: Nov. 11, 2021

(54) MULTICAST DISTRIBUTION TREE ALLOCATION USING MACHINE LEARNING

(71) Applicant: Cisco Technology, Inc., San Jose, CA (US)

(72) Inventors: Mankamana Prasad Mishra, San Jose, CA (US); Jean-Philippe Vasseur, Saint Martin D'uriage (FR); Nitin Kumar, San Jose, CA (US); Rajiv Asati, Morrisville, NC (US); Luc De Ghein, Deinze (BE)

(21) Appl. No.: 16/871,827

(22) Filed: May 11, 2020

(51) Int. Cl. H04L 12/44; H04L 12/18; H04L 12/801; H04L 12/931; G06N 20/00

(52) U.S. Cl. CPC H04L 12/44; H04L 12/1895; G06N 20/00; H04L 49/201; H04L 47/127

(57) ABSTRACT

In one embodiment, a device deploys a first machine learning model to an inference location in a network. The first machine learning model is used at the inference location to make inferences about the network. The device receives, from the inference location, an indication that the first machine learning model is exhibiting poor performance. The device identifies a corrective measure for the poor performance that minimizes resource consumption by a model training pipeline of the device. The device deploys, based on the corrective measure, a second machine learning model to the inference location. The second machine learning model is used in lieu of the first machine learning model to make the inferences about the network.

### TECHNICAL FIELD

The present disclosure relates generally to computer networks, and, more particularly, to multicast distribution tree allocation using machine learning.

### BACKGROUND

Today, multicast distribution trees (MDTs) are often used in service provider networks to distribute multicast traffic to a plurality of different routers. This allows an endpoint to send the same traffic to a variety of receivers via the provider network, simultaneously. For instance, media content (e.g., streaming video) can be efficiently carried across the provider network via an MDT for reception by any number of a plurality of receivers. Example types of traffic that may be conveyed via MDT may include, but are not limited to, broadcast media, financial data, Internet Protocol television (IPTV) data, and the like.

While the use of MDTs can help to efficiently send traffic across a service provider network to a plurality of destination routers, the set of routers that actually require the traffic can change. This can lead to a router receiving traffic sent via an MDT that it does not actually need. In such cases, the router then drops the received traffic. As a result, bandwidth is actually wasted in the service provider network.

### BRIEF DESCRIPTION OF THE DRAWINGS

FIGS. 1A-1B illustrate an example computer network;

FIG. 2 illustrates an example network device/node;

FIGS. 3A-3D illustrate examples of multicast distribution tree allocation in a network;

FIGS. 4A-4D illustrate examples of using machine learning to allocate a multicast distribution tree; and

FIG. 5 illustrates an example simplified procedure for using machine learning for multicast distribution tree allocation.

### DESCRIPTION OF EXAMPLE EMBODIMENTS

### Overview

According to one or more embodiments of the disclosure, a device in a network obtains data regarding multicast traffic in the network. The device maintains a machine learning model configured to model traffic patterns in the network based on the data regarding the multicast traffic in the network. The device identifies, using the machine learning model, a particular multicast traffic flow in the network as being of a particular traffic pattern. The device causes, based on the particular traffic pattern, a multicast distribution tree to be allocated in the network for the particular multicast traffic flow.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

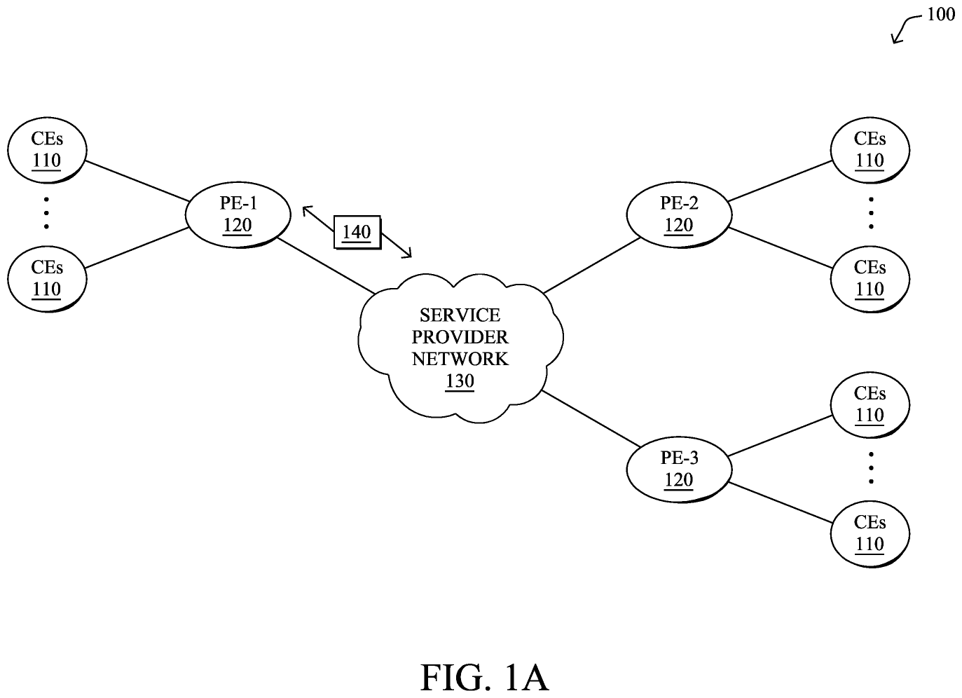

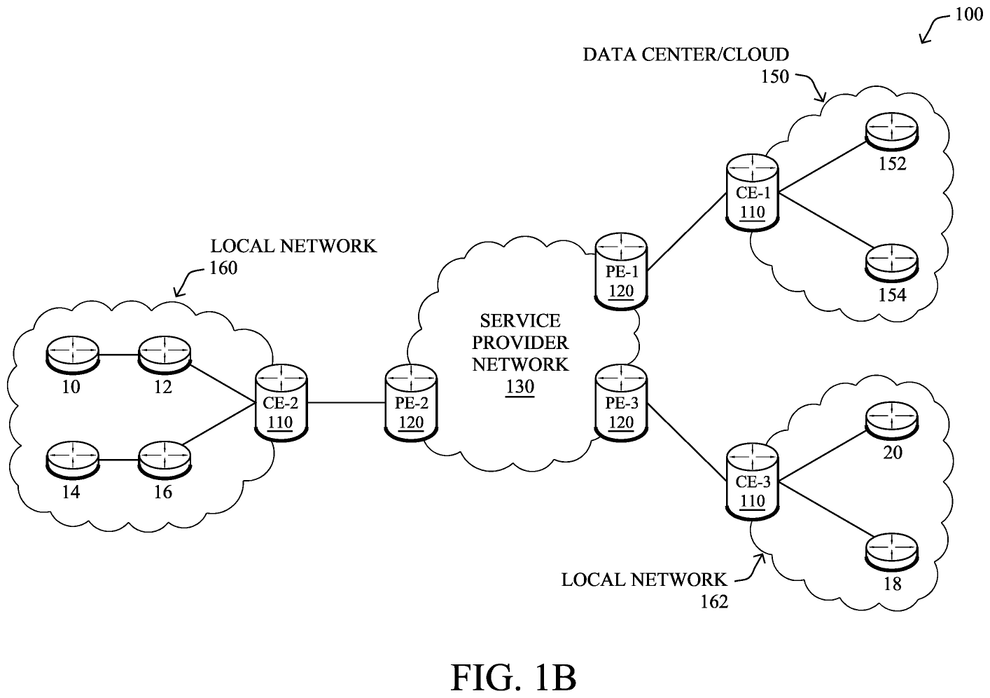

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative service provider network 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, service provider network 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud 150 over an MPLS or Internet-based service provider network 130. Similarly, a second tunnel may also connect these routers over a 4G/5G/LTE cellular service provider network. SD-WAN techniques allow the WAN functions to be virtualized, essentially forming a virtual connection between local network 160 and data center/cloud 150 on top of the various underlying connections. Another feature of SD-WAN is centralized management by a supervisory service that can monitor and adjust the various connections, as needed.

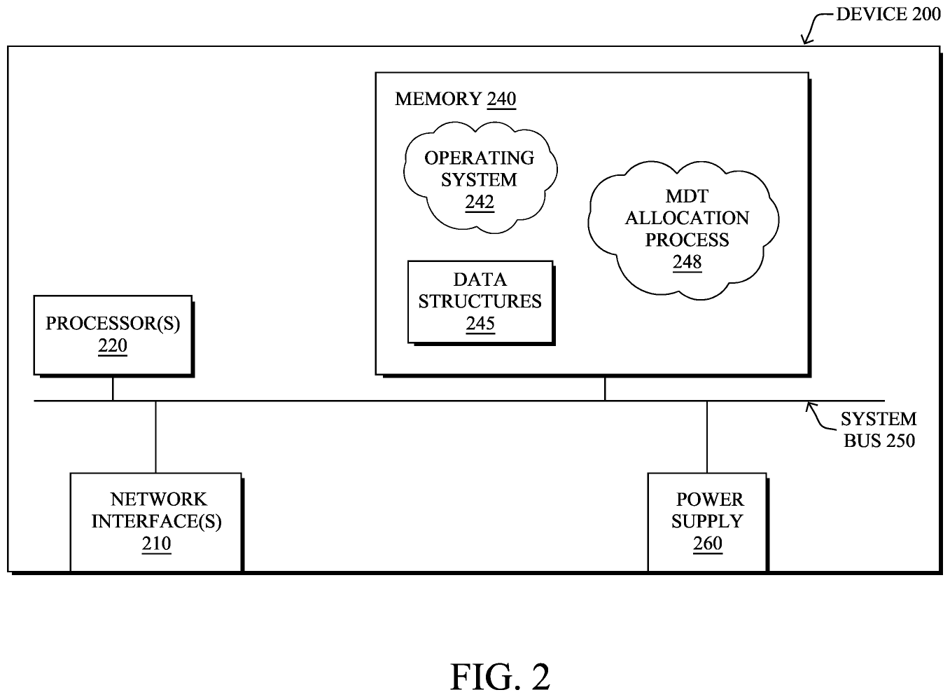

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a multicast distribution tree (MDT) allocation process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, MDT allocation 248 contains computer executable instructions executed by the processor 220 to control the allocation (and deallocation) of MDTs in a network. To do so, in some embodiments, predictive routing process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, MDT allocation process 248 may employ one or more supervised, unsupervised, or semi-supervised machine learning models. Generally, supervised learning entails the use of a training set of data, as noted above, that is used to train the model to apply labels to the input data. For example, the training data may include sample data regarding multicast traffic in a network that has been labeled as exhibiting a particular pattern. On the other end of the spectrum are unsupervised techniques that do not require a training set of labels. Notably, while a supervised learning model may look for previously seen patterns that have been labeled as such, an unsupervised model may instead look to whether there are changes in the behavioral patterns. Semi-supervised learning models take a middle ground approach that uses a greatly reduced set of labeled training data.

Example machine learning techniques that MDT allocation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

As noted above, multicast have been popular choice to convey traffic over a network, such as traffic related to applications such as IPTV broadcast media, financial data, and the like. More specifically, a service provider network may provide connectivity to any number of customers (e.g., enterprises). Each customer network may run its own multicast protocols and the service provider network may also have its own independent multicast protocol. Since multicast creates state in network, in context of VPN there is the notion of a data MDT which allows a service provider to control the amount of state in the core of the network. To achieve this, multicast flows are aggregated and carried over a provider multicast tree.

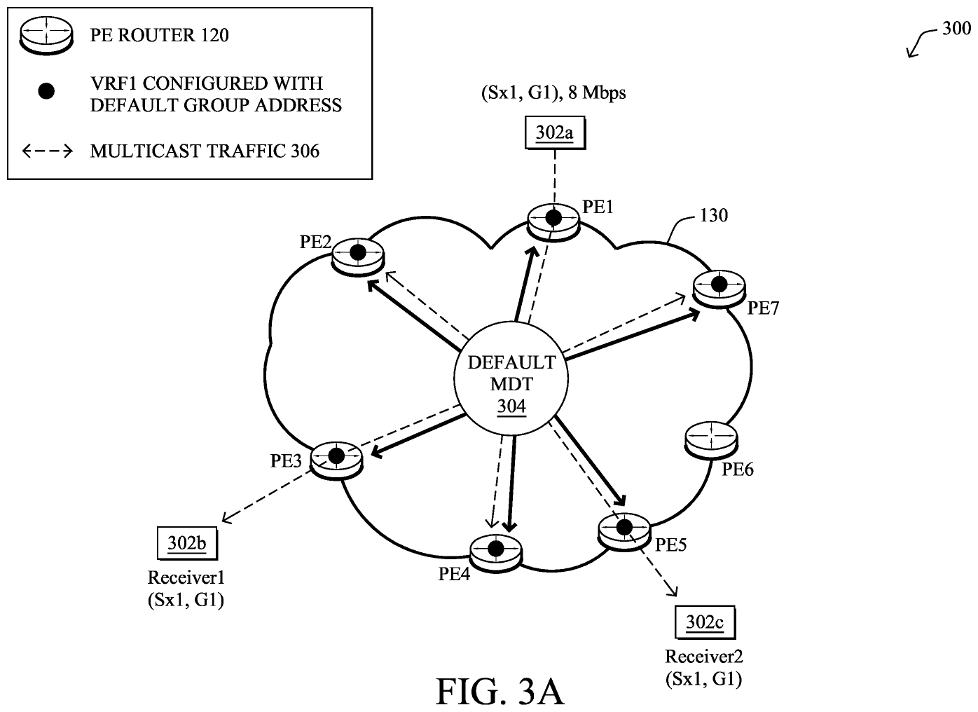

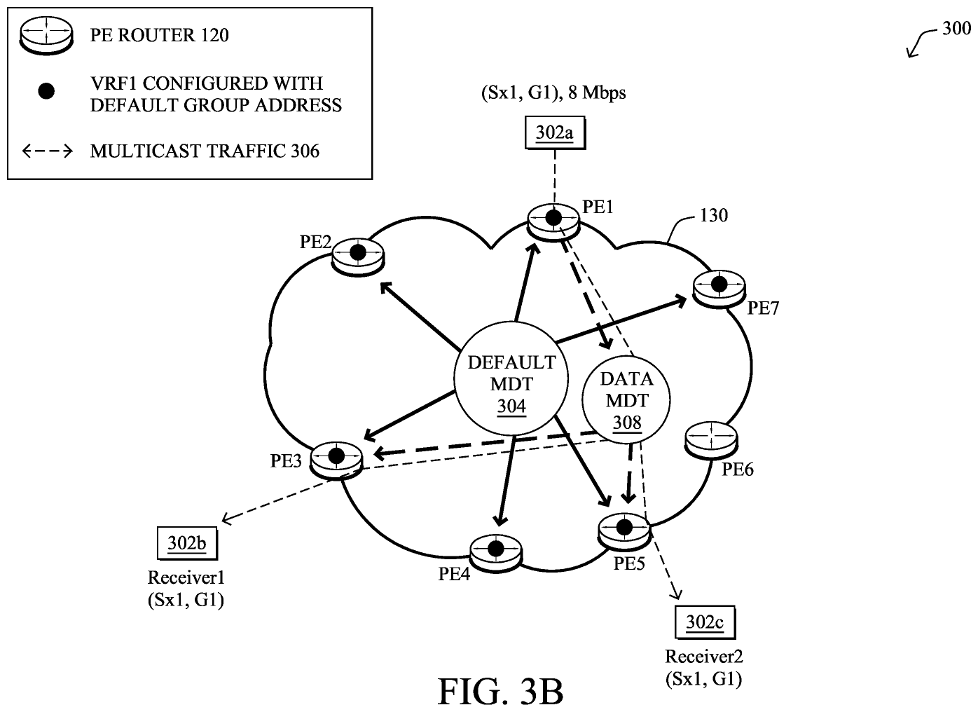

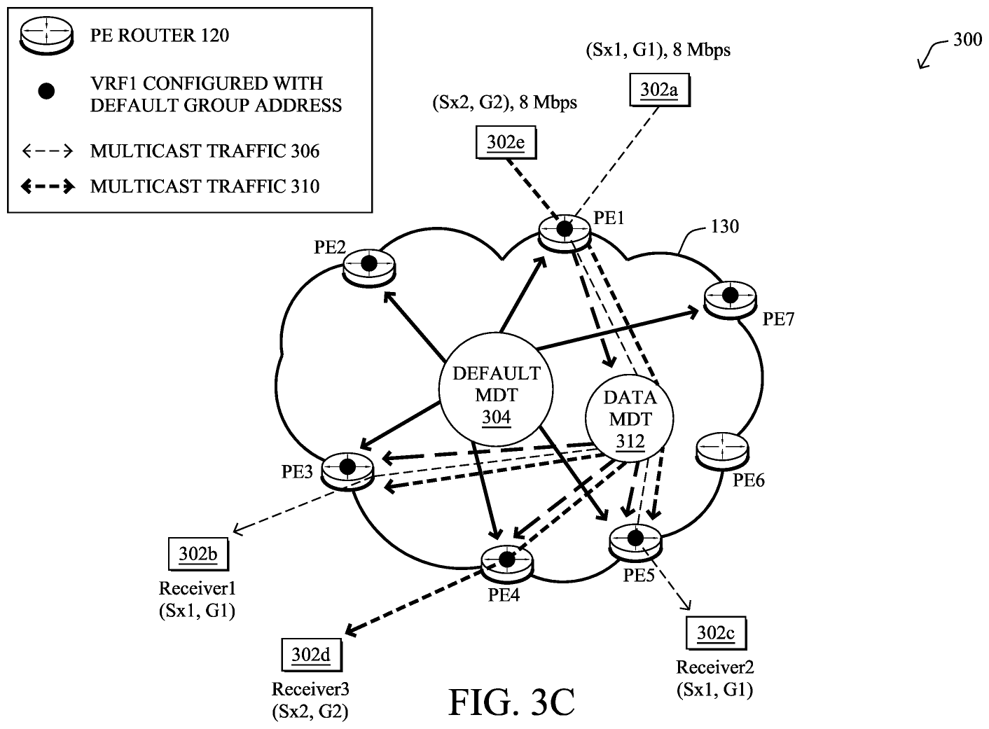

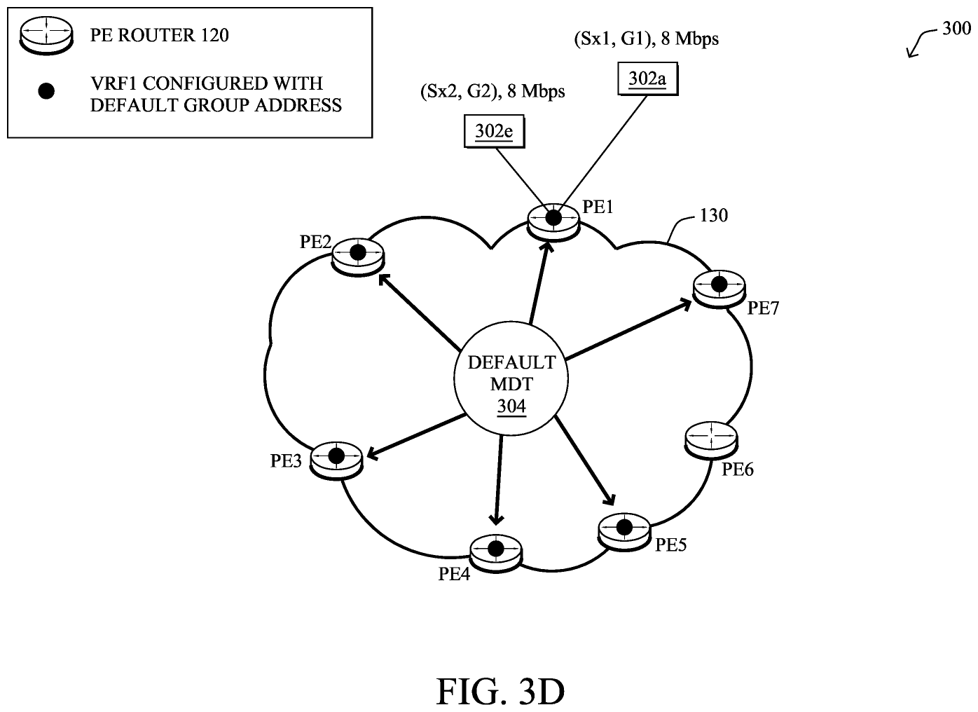

FIGS. 3A-3D illustrate examples of multicast distribution tree allocation in a network, according to various embodiments. Continuing the examples of FIGS. 1A-1B, assume that network 300 includes service provider network 130 that comprises a plurality of PE routers 120: PE1-PE7. As would be appreciated, a provider network may comprise many more PE routers 120 and that the examples in FIGS. 3A-3D represent simplified examples for purposes of illustration. Each PE router 120 may be connected to a corresponding CE router (not shown), to provide connectivity to any number of endpoints 302.

As shown in FIG. 3A, assume that there are three endpoints 302: an endpoint 302a that is to supply video feed data as multicast traffic 306 to remote endpoints 302b-302c. For instance, endpoint 302a may be located in the headquarters of a company, while endpoints 302b-302c may be located in different branch offices of the company.

To facilitate distribution of multicast traffic 306, there may be a default MDT 304 configured in service provider network 130 that connects PE1, PE2, PE3, PE4, PES, and PE7. To do so, the service provider may leverage Virtual Routing and Forwarding (VRF) or another suitable technology, to configure a VRF1 with a default multicast group address. Thus, multicast traffic 306 may be identified by a source identifier (e.g., Sx1) and a group identifier (e.g., G1).

When endpoint 302a sends multicast traffic 306, PE 1 will direct multicast traffic 306 onto default MDT 304. In turn, PE3 may send multicast traffic 306 on to the first receiver, endpoint 302b, and PE5 may send multicast traffic 306 on to the second receiver, endpoint 302c. However, this also means that routers PE2, PE4, and PE7 will also receive multicast traffic 306, but do not have corresponding endpoints 302 that are to receive the traffic. Accordingly, routers PE2, PE4, and PE7 will simply drop multicast traffic 306.

To address the issue of a default MDT distributing traffic irrespective of the active receivers of the multicast traffic, the concept of a data MDT was introduced. FIG. 3B illustrates an example of a data MDT 308 that has been allocated in service provider network 130. Typically, the source router, such as PE1 in the example shown, will be configured with a bandwidth threshold that controls its use of data MDT 308. As a result, each traffic flow in the particular VRF (e.g., VRF1) whose bandwidth meets or exceeds the threshold will be switched over from default MDT 304 to data MDT 308, to help minimize the amount of wasted bandwidth. For instance, if the bandwidth of multicast traffic 306 exceeds the predefined threshold configured at router PE1, router PE1 may migrate multicast traffic 306 onto data MDT 308. As a result, multicast traffic 306 is now only sent to routers PE3 and PE5, that is, the routers that should actually receive multicast traffic 306.

Each data MDT in a network creates additional state in the core network. To help reduce the amount of state in the network, it is a common practice to aggregate data MDT allocations. For instance, as shown in FIG. 3C, assume now that there is an additional source endpoint, endpoint 302e that sends multicast traffic 310 destined for endpoints including endpoint 302d (Sx2, G2). In many deployments today, multicast traffic 310 and multicast traffic 306 may be aggregated onto the same data MDT 312.

While allocating a data MDT to distributed an aggregated set of multicast traffic can help to reduce state in the network, doing so can also lead to the same situation as using the default MDT: bandwidth and resources being needlessly consumed by delivering multicast traffic to routers that do not need the traffic. In even more extreme cases, the aggregated data MDT may even match, or closely match, the default MDT.

By way of example, consider the case in FIG. 3D. Assume that routers PE2, PE3, and PE4 have active receivers for C(S1, G1) and that routers PES, PE6, and PE7 have active receivers for C(S2, G2). If both multicast traffic flows are mapped to the same data MDT, this would effectively recreate default MDT 304.

A key observation is that many multicast traffic flows exhibit common patterns. For example, out of hundreds of flows, certain flows may be live telecasts of specific events or financial data that is only sent on weekdays during defined hours. Today, data MDT allocation does not take these patterns into account, leading to cases in which bandwidth and other resources are wasted. Indeed, currently implemented MDT allocations use a round robin approach, which can lead to the non-optimal forwarding of multicast traffic whereby PE routers with no active receivers end up dropping the traffic. In addition, MDT allocation today also does not take into account future events. For instance, many sporting events are planned well in advance and result in multimedia multicast traffic.

### Multicast Distribution Tree Allocation Using Machine Learning

The techniques herein introduce a machine learning-based approach to optimize multicast traffic in a network via MDTs. In some aspects, a machine learning model can be trained to identify various traffic patterns and use this information to optimize the allocation of MDTs in the network. In further aspects, machine learning can also be used to predict the patterns of future multicast traffic flows, allowing the system to proactively direct the traffic onto an optimal MDT allocated in the network.

Specifically, according to one or more embodiments herein, a device in a network obtains data regarding multicast traffic in the network. The device maintains a machine learning model configured to model traffic patterns in the network based on the data regarding the multicast traffic in the network. The device identifies, using the machine learning model, a particular multicast traffic flow in the network as being of a particular traffic pattern. The device causes, based on the particular traffic pattern, a multicast distribution tree to be allocated in the network for the particular multicast traffic flow.

Illustratively, the techniques described herein may be performed by hardware, software, and/or firmware, such as in accordance with the MDT allocation process 248, which may include computer executable instructions executed by the processor 220 (or independent processor of interfaces 210) to perform functions relating to the techniques described herein.

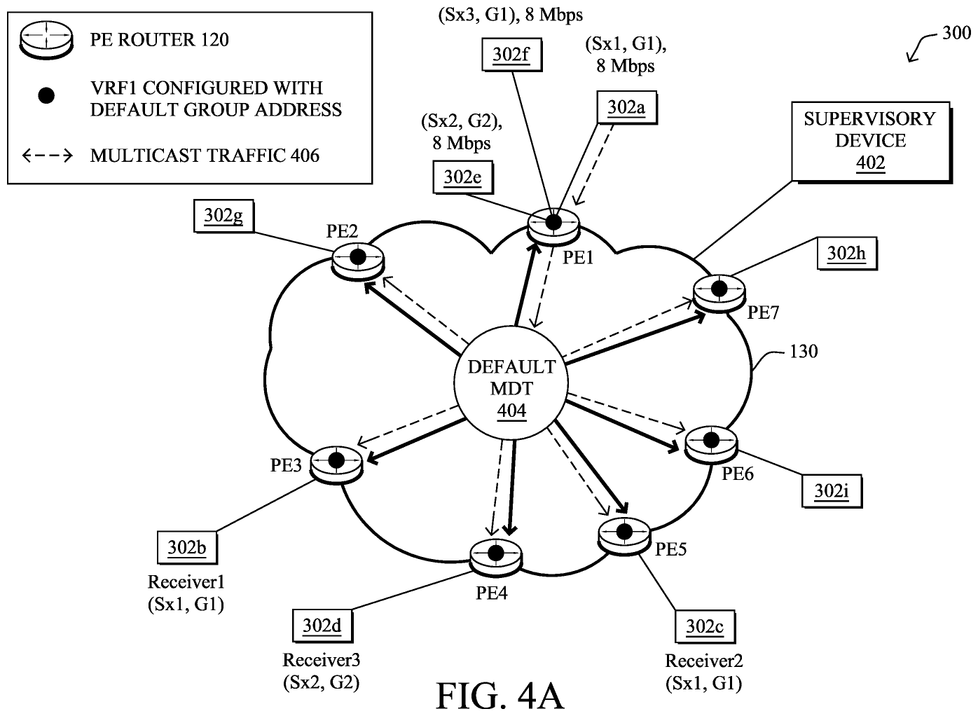

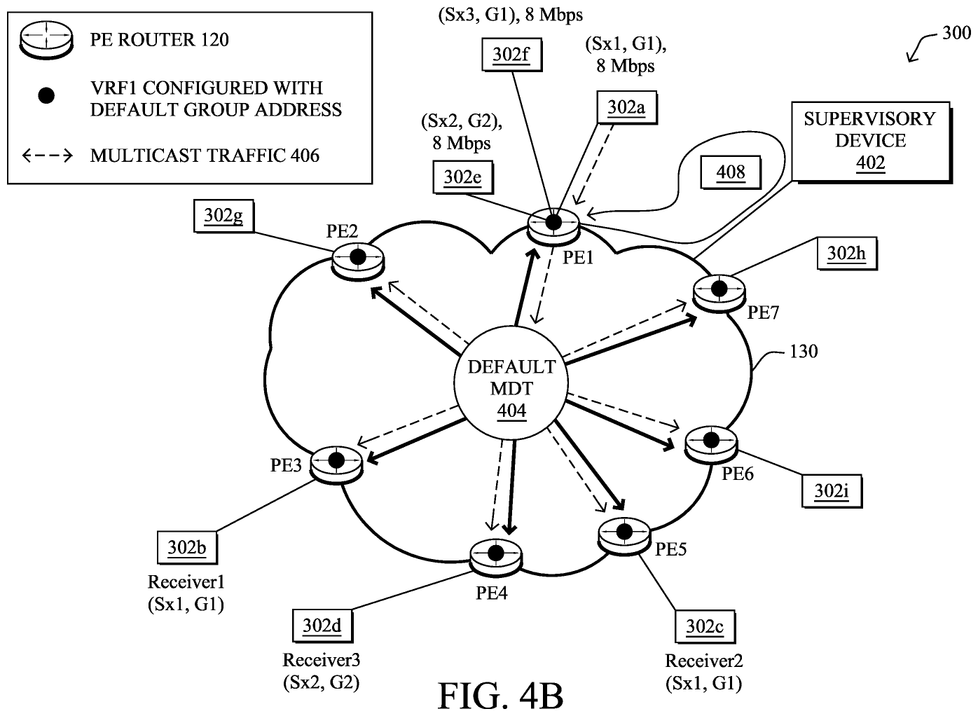

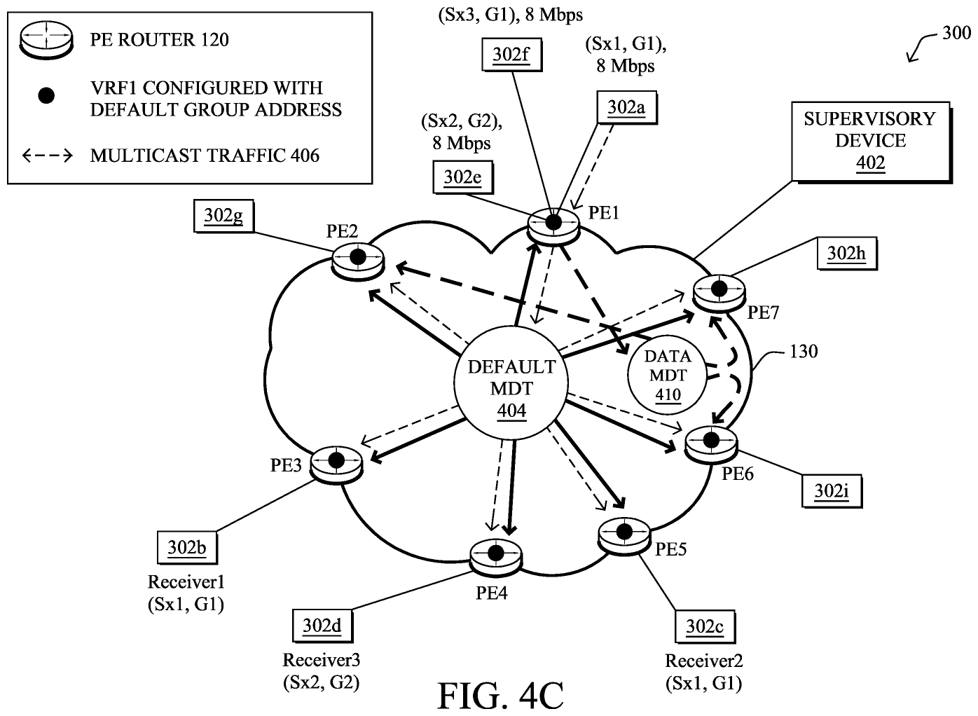

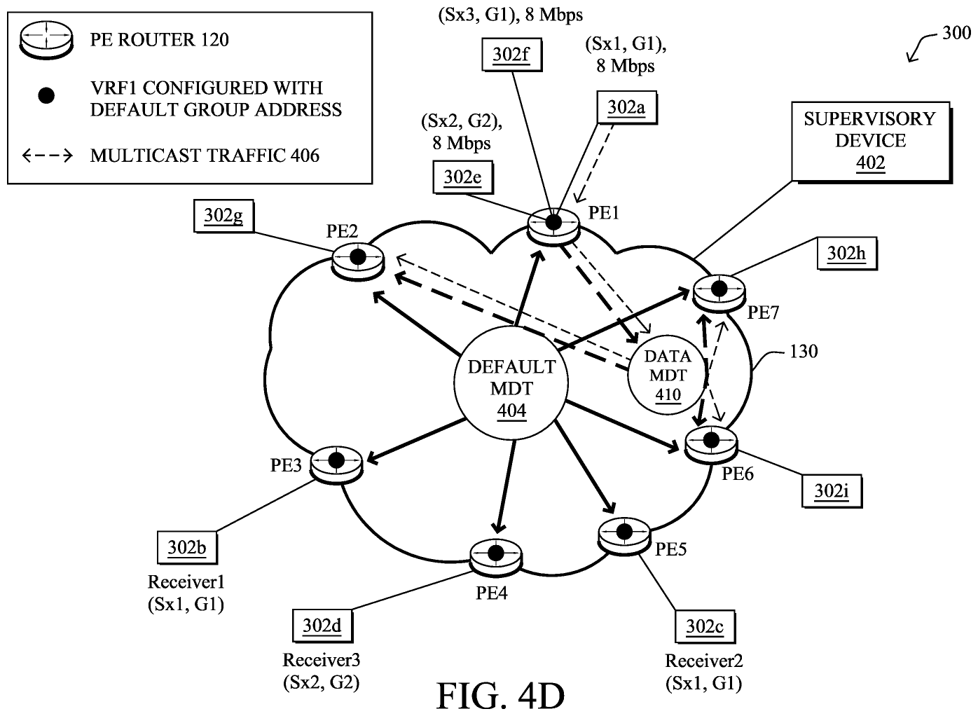

Operationally, FIGS. 4A-4D illustrate examples of using machine learning to allocate a multicast distribution tree (MDT) in a network, according to various embodiments. As shown in FIG. 4A, consider again the example network 300 from FIGS. 3A-3D whereby there is a service provider network 130 comprising a set of PE routers 120: PE1-PE7 at its edge. In addition, each of routers PE2-PE7 may have a corresponding receiver endpoint 302. For instance, PE2 may send traffic from the provider network on to endpoint 302g, PE3 may send traffic from the provider network on to endpoint 302b, PE4 may send traffic from the provider network on to endpoint 302d, PE5 may send traffic from the provider network on to endpoint 302c, PE6 may send traffic from the provider network on to endpoint 302i, and PE7 may send traffic from the provider network on to endpoint 302h.

In addition to receiver endpoints 302, assume also that there are three source endpoints 302 that send traffic into the provider network via PE1: a first source endpoint 302a, a second source endpoint 302b, and a third source endpoint 302c (e.g., a media content server). Accordingly, multicast traffic from each of these source endpoints 302 may be identified by a corresponding source-group pair that indicates which endpoint 302 sent the traffic and the multicast group number.

According to various embodiments, network 300 may also include a supervisory device 402 that functions as a machine learning agent for the provider network. In various embodiments, supervisory device 402 may be a separate server or set of servers or other devices that perform the machine learning techniques introduced herein, in which case the set of servers or other devices can be viewed as a singular device for purposes of providing supervisory control over PE routers 120. In further embodiments, supervisory device 402 may take the form of a PE router 120 by executing the machine learning model directly on the router.

During operation, supervisory device 402 may receive data regarding the various multicast traffic flows in the service provider network 130 between PE routers 120. For instance, such data may indicate any or all of the following metadata:
Timing information—for instance, the collected metadata for a particular multicast traffic flow may indicate the start time of the flow and/or the end time of the flow.
Source information—the collected metadata may also indicate the source of the multicast traffic flow and/or its source router.
Destination information—the collected metadata may also indicate destination endpoints of the multicast traffic flow and/or the destination PE routers of the multicast traffic flow.
Application information—in some cases, the collected metadata may also indicate the type of application associated with the multicast traffic flow. For instance, the collected metadata may indicate that the flow comprises financial data, video traffic for satellite distribution, enterprise conference video traffic, or the like.
Event information—in various embodiments, supervisory device 402 may also receive information regarding any events associated with a particular multicast traffic flow. For instance, this information may indicate that the flow is associated with a prescheduled game, live event, or the like.

Generally speaking, supervisory device 402 may receive the above information from PE routers 120 or other telemetry collectors located in service provider network 130. In cases in which supervisory device 402 also receives event information, such event information may be entered manually or obtained from a news service or other resource that stores event information, such as in accordance with a defined policy. In further embodiments, supervisory service 402 may learn the seasonality of certain events over time through observation of their corresponding traffic.

Using the received information regarding the multicast traffic flows, supervisory device 402 may train a machine learning model to classify and/or predict certain traffic patterns in service provider network 130. For example, the model may determine that multicast traffic involving financial data is only active on certain days of the week and at specific times. Note also that the receivers of the financial data and other application data could differ from customer to customer, which the model can also take into account.

By way of example, assume that video data is always multicast from router PEI to routers PE2, PE6, and PE7, whose corresponding endpoints 302g, 302i, and 302h, respectively, are satellite broadcasting devices. Further, assume that financial data is always multicast to routers PE3, PE4, and PE5 between 9:00 AM and 5:00 PM Monday through Friday. In these and other cases, supervisory service 402 can train its machine learning model to identify these traffic patterns when they occur and, potentially, predict their occurrence, as well.

In various embodiments, example traffic patterns that can be learned by the machine learning model of supervisory service 402 may include any or all of the following:
Financial Data
   Active only from “x” AM to “y” PM
   Active only from Monday to Friday
   Set of receivers only at a, b. c
Video Traffic
   Satellite distribution always from same set of locations
   Possible set of customer flows which map to satellite distribution traffic
Enterprise Conference Video Traffic
   List of receiving locations
Etc.

After learning the various traffic patterns in service provider network 130, the machine learning model of supervisory service 402 can use these identified patterns to aid in the determination of which multicast traffic flows can be combined together in a data MDT. For instance, assume that data MDTs are available for the following range of IP addresses: 231.1.1.1 to 232.1.1.10. In such a case, supervisory service 402 may assign different types of traffic to different multicast addresses, based on their corresponding patterns. For instance, satellite distribution video traffic may be assigned to 232.1.1.3, financial data assigned to 232.1.1.5, etc.

To illustrate the operation of the machine learning-based MDT allocation process, assume that endpoint 302a begins sending video traffic as multicast traffic 406 via default MDT 404 and destined for endpoints 302g, 302i, and 302h. As a result, each of routers PE2-PE7 will receive multicast traffic 406, leading to PE3-PE5 dropping multicast traffic 406. However, since this video traffic is often repeated, the machine learning model of supervisory device 402 may have already learned its traffic pattern.

As shown in FIG. 413, prior to allocating a data MDT as a result of multicast traffic 406, router PEI may initiate an exchange 408 in which it sends information regarding multicast traffic 406 to supervisory device 402. In turn, supervisory device 402 may use its machine learning model to identify the pattern of multicast traffic 406, based on this identification, send instructions back to PE1 regarding the appropriate data MDT allocation.

In turn, as shown in FIG. 4C, PE1 may allocate data MDT 410 and notify each of the corresponding PE routers 120 about the allocation of data MDT 410 for multicast traffic 406. For instance such a notification may indicate the IP address of source endpoint 302a (e.g., 192.168.1.1) and the group IP address (e.g., 233.1.1.1). This allows the PE routers 120 with local receivers that are interested in multicast traffic 406, i.e., PE2, PE6, and PE7 to join data. MDT 410. Note that the decision to allocate data. MDT 410 by supervisory service 402 may, in various embodiments, also take into account the traffic patterns of other multicast traffic in service provider network 130 or are predicted to occur.

Finally, as shown in FIG. 4D, once PE2, PE6, and. PE7 join data MDT 510 traffic, only those PE routers 120 will receive multicast traffic 506, thereby conserving bandwidth in service provider network 130.

In further embodiments, the machine learning model of supervisory device 402 may predict the presence of multicast traffic 406 before it is sent, based on external event information or seasonality of multicast traffic 406. In such cases, supervisory device 402 may proactively send a data. MDT allocation policy to router PEI before endpoint 302a sends multicast traffic 406. This allows PE1 to allocate data MDT 410 when needed, without first having to query supervisory device 402.

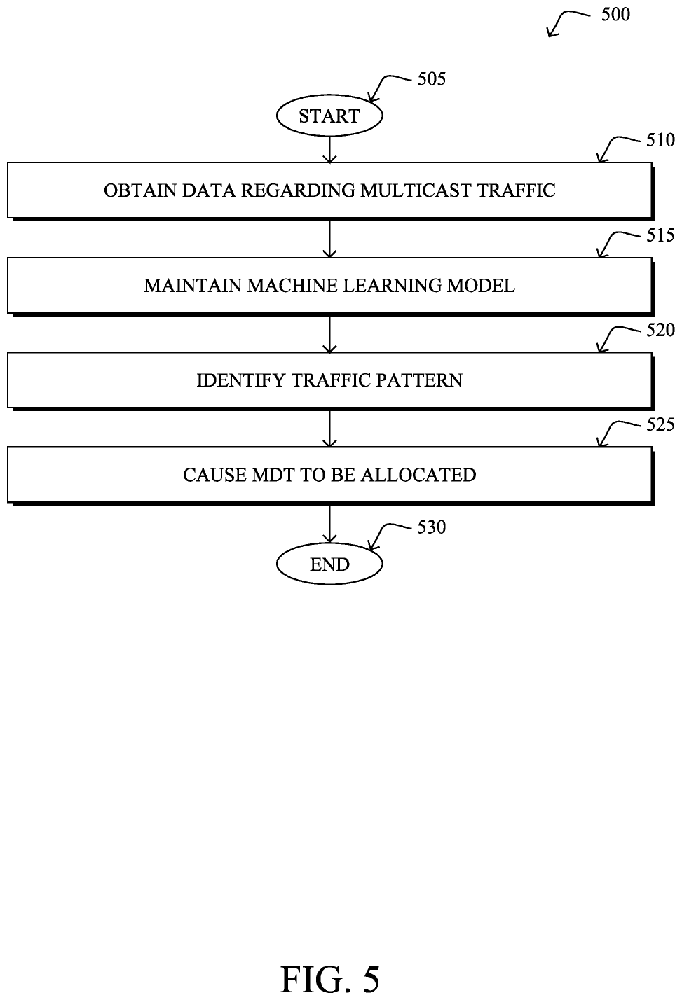

FIG. 5 illustrates an example simplified procedure for using machine learning for multicast distribution tree allocation, in accordance with one or more embodiments described herein. For example, a non-generic, specifically configured device (e.g., device 200) may perform procedure 500 by executing stored instructions (e.g., process 248). As shown, the procedure 500 my start at step 505 and continue on to step 510 where, as described in greater detail above, the device may obtain data regarding multicast traffic in the network. In some embodiments, the network may be a service provider network that connects a plurality of PE routers.

At step 515, as detailed above, the device may maintain a machine learning model configured to model traffic patterns in the network based on the data regarding the multicast traffic in the network. In various embodiments, the device may update the model over time by training it to detect new traffic patterns in the network.

At step 520, the device may identify, using the machine learning model, a particular traffic flow in the network as being of a particular traffic pattern, as described in greater detail above. In some embodiments, the device may receive a request from a particular router in the network that comprises data regarding the particular flow. In turn, the device may use that data as input to the machine learning model, to identify the particular flow as being of the particular pattern. In further embodiments, the device may make the identification by predicting that the particular traffic pattern will occur in the network, allowing the device to proactively allocate an MDT for that upcoming flow.

At step 525, as detailed above, the device may cause an MDT to be allocated in the network for the particular multicast traffic flow, based on the particular traffic pattern.

To do so, the device may notify each of a plurality of routers in the network regarding allocation of the MDT. In turn, the particular traffic flow may be migrated from a default MDT in the network to the allocated MDT. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for better usage of bandwidth in a network carrying multicast traffic by using machine learning to recognize traffic patterns and use those patterns to allocate appropriate data MDTs in the network.

While there have been shown and described illustrative embodiments that provide for using machine learning to allocate MDTs in a network it is to be understood that various other adaptations and modifications may be made within the spirit and scope of the embodiments herein. For example, while certain embodiments are described herein with respect to using certain models for purposes of identifying or predicting traffic patterns, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a device in a network, data regarding multicast traffic in the network;
maintaining, by the device, a machine learning model configured to model traffic patterns in the network based on the data regarding the multicast traffic in the network;
identifying, by the device and using the machine learning model, a particular multicast traffic flow in the network as being of a particular traffic pattern; and
causing, by the device and based on the particular traffic pattern, a multicast distribution tree to be allocated in the network for the particular multicast traffic flow.

2. The method as in claim 1, wherein the multicast distribution tree connects a plurality of provider edge (PE) routers in the network.

3. The method as in claim 1, wherein identifying the particular multicast traffic flow in the network as being of a particular traffic pattern:
using the machine learning model to predict that the particular traffic pattern will occur in the network, wherein the multicast distribution tree is allocated proactively for the particular multicast traffic flow.

4. The method as in claim 1, wherein identifying the particular traffic pattern in the network comprises:
receiving a request from a particular router in the network that comprises data regarding the particular multicast traffic flow; and
using the data regarding the particular multicast traffic flow as input to the machine learning model, to identify the particular multicast traffic flow as being of the particular traffic pattern.

5. The method as in claim 4, wherein the data regarding the particular multicast traffic flow is indicative of an application type associated with the particular multicast traffic flow.

6. The method as in claim 1, wherein causing the multicast distribution tree to be allocated in the network for the particular multicast traffic flow comprises:
notifying each of a plurality of routers in the network regarding allocation of the multicast distribution tree.

7. The method as in claim 6, wherein the particular multicast traffic flow is migrated from a default multicast distribution tree in the network to the multicast distribution tree.

8. The method as in claim 1, further comprising:
training the machine learning model to detect a new traffic pattern in the network.

9. An apparatus, comprising:
one or more network interfaces;
a processor coupled to the one or more network interfaces and configured to execute one or more processes; and
a memory configured to store a process that is executable by the processor, the process when executed configured to:
obtain data regarding multicast traffic in a network;
maintain a machine learning model configured to model traffic patterns in the network based on the data regarding the multicast traffic in the network;
identify, using the machine learning model, a particular multicast traffic flow in the network as being of a particular traffic pattern; and
cause, based on the particular traffic pattern, a multicast distribution tree to be allocated in the network for the particular multicast traffic flow.

10. The apparatus as in claim 9, wherein the multicast distribution tree connects a plurality of provider edge (PE) routers in the network.

11. The apparatus as in claim 9, wherein the apparatus identifies the particular multicast traffic flow in the network as being of a particular traffic pattern by:
using the machine learning model to predict that the particular traffic pattern will occur in the network, wherein the multicast distribution tree is allocated proactively for the particular multicast traffic flow.

12. The apparatus as in claim 9, wherein the apparatus identifies the particular multicast traffic flow in the network as being of a particular traffic pattern by:
receiving a request from a particular router in the network that comprises data regarding the particular multicast traffic flow; and
using the data regarding the particular multicast traffic flow as input to the machine learning model, to identify the particular multicast traffic flow as being of the particular traffic pattern.

13. The apparatus as in claim 12, wherein the data regarding the particular multicast traffic flow is indicative of an application type associated with the particular multicast traffic flow.

14. The apparatus as in claim 9, wherein the apparatus causes the multicast distribution tree to be allocated in the network for the particular multicast traffic flow by:
notifying each of a plurality of routers in the network regarding allocation of the multicast distribution tree.

15. The apparatus as in claim 14, wherein the particular multicast traffic flow is migrated from a default multicast distribution tree in the network to the multicast distribution tree.

16. The apparatus as in claim 9, wherein the process when executed is further configured to:
train the machine learning model to detect a new traffic pattern in the network.

17. A tangible, non-transitory, computer-readable medium storing program instructions that cause a device in a network to execute a process comprising:
obtaining, by the device, data regarding multicast traffic in the network;
maintaining, by the device, a machine learning model configured to model traffic patterns in the network based on the data regarding the multicast traffic in the network;
identifying, by the device and using the machine learning model, a particular multicast traffic flow in the network as being of a particular traffic pattern; and causing, by the device and based on the particular traffic pattern, a multicast distribution tree to be allocated in the network for the particular multicast traffic flow.

18. The computer-readable medium as in claim 17, wherein identifying the particular multicast traffic flow in the network as being of a particular traffic pattern:
using the machine learning model to predict that the particular traffic pattern will occur in the network, wherein the multicast distribution tree is allocated proactively for the particular multicast traffic flow.

19. The computer-readable medium as in claim 17, wherein identifying the particular traffic pattern in the network comprises:
receiving a request from a particular router in the network that comprises data regarding the particular multicast traffic flow; and
using the data regarding the particular multicast traffic flow as input to the machine learning model, to identify the particular multicast traffic flow as being of the particular traffic pattern.

20. The computer-readable medium as in claim 19, wherein causing the multicast distribution tree to be allocated in the network for the particular multicast traffic flow comprises:
notifying each of a plurality of routers in the network regarding allocation of the multicast distribution tree.
